(19) United States
(12) Patent Application Publication
(10) Pub. No.: US 2010/0159276 A1
(43) Pub. Date: Jun. 24, 2010

(54) Galvanized rolling-hardened cold-rolled flat product and process for producing it

(75) Inventors: Peter Biele, Duisburg (DE); Ralph Goecke, Herne (DE); Peter Klauke, Schwerte (DE); Markus Lohe, Bottrop (DE)

Correspondence Address: PROSKAUER ROSE LLP, ONE INTERNATIONAL PLACE, BOSTON, MA, 02110, US

(73) Assignee: ThyssenKrupp Steel AG, Duisburg (DE)

(21) Appl. No.: 12/160,532

(22) PCT Filed: Jan. 3, 2007
(86) PCT No.: PCT/EP07/50042

§ 371 Date: Nov. 4, 2008

(30) Foreign Application Priority Data
Jan. 11, 2006 (DE) 10 2006 001 628.9

(51) Int. Cl. B32B 15/01; C25D 5/36

(52) U.S. Cl. 428/659; 205/206

(57) ABSTRACT

A flat product according to the invention which has been produced from a low-alloy steel containing iron and unavoidable impurities together with (in % by weight) up to 0.45% of C, up to 2.20% of Si, up to 2.50% of Mn, up to 0.12% of P, up to 0.025% of S, up to 2.0% of Al, up to 0.15% of Ti, up to 0.09% of Nb, a total of up to 1.0% of Cr and Mo, up to 0.2% of V and up to 0.005% of B and has been cold-rolled to a thickness of 0.1-4 mm and is in the rolling-hardened state has a tensile strength of 700-1000 MPa and is coated with a zinc layer which has been applied by electrolytic galvanization and has a layer thickness of up to 12 μm. The cold-rolled flat product of this type provides a steel sheet or strip which has not only a particularly high strength but also a high corrosion resistance. In addition, the invention provides a process for producing such a flat product.

### CROSS-REFERENCE TO RELATED APPLICATIONS

This application is a National Phase Application of International Patent Application No. PCT/EP2007/050042, filed on Jan. 3, 2007, which claims the benefit of and priority to German Patent Application No. DE 10 2006 001 628.9-24, filed Jan. 11, 2006, which is owned by the assignee of the instant application. The disclosure of each of these applications is incorporated herein by reference in its entirety.

### FIELD OF THE INVENTION

The invention relates to a galvanized cold-rolled flat product produced from a low-alloy steel, such as cold strip or cold-rolled steel sheet of high strength and a process for producing it.

### BACKGROUND OF THE INVENTION

In the steel-processing industry, the demand exists for economic steel sheet, which with low weight is suitable for such applications, wherein high strength is of prime importance while the malleability and ductility of the steel sheet processed in each case are secondary. An example of such an application are profiles, from which doors and gates are manufactured. In particular, steel sheet of the type under consideration here is needed for producing thin plates, from which rolling gates, roller shutters or comparable elements are constructed.

Another example of the use of steel sheet of the type under consideration here is transmission or clutch construction, wherein economic steel sheet of low weight and high strength is needed with regard to the greatest possible saving of weight, especially for the production of parts, which are simply shaped but highly loaded in use.

A process, which facilitates the production of such steel sheet, is described in the Japanese Patent JP 200589853 A. In this known process firstly a hot strip, whose micro-structure contains certain perlite and cementite fractions as well as ferrite grains of a specific size is produced from a low alloy steel which contains (in % by weight) 0.15-0.25% of C, up to 0.25% of Si, 0.3-0.9% of Mn, up to 0.025% of P, 0.005% of S, up to 0.08% of Al, 0.008% of N, up to 0.07% of Ti, up to 0.006% of B and as a remainder iron and unavoidable impurities. This hot strip without annealing is then rolled with cold rolling reductions of at least 50% to form cold strip. Because the strip obtained in this way is also further processed without recrystallizing annealing after the cold-rolling, when it is made into the particular component, it has the high strength, which was bestowed in the course of cold-rolling by cold strain-hardening of the steel. This “rolling-hardened” state of cold-rolled steel sheet, which has not undergone recrystallizing annealing, is also known in technical parlance as “full-hard”.

In order to bestow the necessary corrosion resistance on the full-hard steel sheet used in the house building industry, such steel sheet today is normally hot-dip galvanized. This has the advantage that a high thickness of the zinc layer can be reliably produced also on the relatively uneven, highly strain-hardened cold-rolled strip substrate. In addition, high throughput can be achieved in modern hot-dip galvanizing plants. However, this economic advantage is faced with the disadvantage that the steel sheet, delivered in the full-hard state, in the course of hot-dip galvanizing, must be heated before its entry into the zinc bath to at least the temperature of the latter, which is typically in the range of 475° C.

Even if this temperature is substantially lower than the recrystallization temperature of the particular steel, this heating acts as tempering. Heating to the zinc bath temperature therefore leads to a reduction in the tensile strength of the cold strip delivered in the full-hard state due to the hot-dip galvanizing. Full-hard cold strip, which is hot-dip galvanized, therefore possesses typical tensile strengths which are in the range of 500-700 MPa.

Although JP 10176253 A describes an attempt to minimize the tensile strength reduction occurring in the course of hot-dip galvanizing, wherein each section of the steel strip entering the zinc bath is brought to the required temperature only directly before its entry into the bath by tightly concentrated inductive heating, the cost of the equipment and control technology necessary for this is so considerable that in practice the known process has proved to be uneconomic.

### SUMMARY OF THE INVENTION

In one aspect, embodiments of the invention provide a cold-rolled flat steel product in the rolling-hardened, full-hard state, which has not only particularly high strength but also a high corrosion resistance. In addition, a process for producing such a flat product is also provided.

In another embodiment in accordance with the invention, a cold-rolled flat product is provided which is produced from a low alloy steel, which in addition to iron and unavoidable impurities contains (in % by weight) up to 0.45% of C, up to 2.20% of Si, up to 2.50% of Mn, up to 0.12% of P, up to 0.025% of S, up to 2.0% of Al, up to 0.15% of Ti, up to 0.09% of Nb, a total of up to 1.0% of Cr and Mo, up to 0.2% of V and up to 0.005% of B, has a thickness of 0.1-4 mm, is in the rolling-hardened state and thereby possess a tensile strength of 700-1000 MPa and which is coated with a zinc layer, which is applied by electrogalvanization and has a layer thickness of up to 12 μm.

In another embodiment in accordance with the invention a process to produce a galvanized rolling-hardened cold-rolled flat product possessing a tensile strength of 700-1000 MPa includes:
producing a hot strip from a steel, which in addition to iron and unavoidable impurities contains (in % by weight) up to 0.45% of C, up to 2.20% of Si, up to 2.50% of Mn, up to 0.12% of P, up to 0.025% of S, up to 2.0% of Al, up to 0.15% of Ti, up to 0.09% of Nb, a total of up to 1.0% of Cr and Mo, up to 0.2% of V and up to 0.005% of B,
cold-rolling the hot strip with a rolling reduction of more than 30% to form a cold rolled flat product, which has a thickness of 0.1-4 mm,
   and
subjecting the cold-rolled flat product in the rolling-hardened state to electrogalvanization, to apply a zinc layer up to 12 μm thick onto the cold-rolled flat product.

### DESCRIPTION

In accordance with embodiments of the invention, a cold-rolled flat product, produced without annealing from a steel of given composition, such as cold strip or cold-rolled steel sheet, in the rolling-hardened state, wherein it has a tensile strength of at least 700 MPa with an elongation of less than 1% (tensile strength z elongation limit), is coated with a zinc layer in an electrogalvanization plant. Surprisingly, in this embodiment it has been shown that the zinc layer produced on the full-hard cold strip in the course of electrolytic deposition, despite its unevenness, is continuously thick and achieves a thickness, uniformity and density, which for the respective intended purpose reliably provides sufficient corrosion resistance of the cold strip or steel sheet composed and produced according to the invention. At the same time, it has been shown that the cold-rolled flat product according to an embodiment of the invention during the course of electrogalvanization at least maintains the tensile strength reached after cold-rolling, even an increase in the tensile strength being the case, so that for strip and steel sheet produced and composed according to the invention, tensile strengths of more than 700 MPa, typically more than 800 MPa, could be regularly achieved. Equally, surprisingly in this connection it has been proved that the high tensile strength of the flat material according to embodiments of the invention, possibly further increased via the electrogalvanization, does not prevent its possible further deformation in the context of its minimized malleability. Thus, simply shaped profile elements, such as thin plates for rolling gates or roller shutters, can be produced from products according to embodiments of the invention by turning on edge, bending or roll forming, which due to their slight material thickness have a low weight and ensure good thermal insulation but due to their particularly high strength also possess particularly high rigidity and correspondingly high resistance to buckling. This combination of characteristics renders products according to embodiments of the invention particularly suitable for those applications in which the respective component is exposed to wide surface area loads, for example by wind or comparable forces.

Dependent upon the respective use, cold-rolled strip or steel sheet according to embodiments of the invention can be provided with a thickness of 0.1-3 mm, wherein for typical applications its thickness may be in the range of 0.1-1.0 mm, particularly up to 0.8 mm.

The corrosion-protective effect of the zinc layer present on cold-rolled flat products according to embodiments of the invention can be reliably ensured by the fact that the zinc layer is at least 2 μm thick. Typical layer thicknesses in this case are 2.5 μm, 7.5 μm or 10 μm. A preferred layer thickness range accordingly lies in the range of 2-10 μm, particularly 4-8 μm.

Apart from the zinc layer deposited electrolytically according to the invention, cold-rolled full-hard steel materials according to some embodiments of the invention can support at least one further coating, such as a paint finish, powder coating or comparable layers, on the zinc layer.

Particularly high cold strain-hardening and the particularly high strength values associated therewith can be achieved through correspondingly high rolling reductions obtained in the course of the cold-rolling carried out if necessary in multiple stages. In this respect, it may be expedient if the rolling reduction achieved during cold-rolling is at least 50%.

For proof of the effect of the invention, firstly a thin slab was cast in a conventional casting rolling plant from a low alloy steel containing (in % by weight) 0.034% of C, 0.023% of Si, 0.24% of Mn, 0.009% of P, 0.006% of S, 0.037% of Al, 0.031% of Cr, 0.0029% of Mo, 0.0004% of Ti, 0.001% of V, 0.001% of Nb and remainder iron as well as further unavoidable impurities and a hot strip was hot-rolled from this. Then, from this hot strip a 0.35 mm thick cold strip, whose tensile strength in the non-annealed, rolling-hardened state was 841 Mpa, was produced with a cold rolling reduction of 82%.

The full-hard material produced in this way was then coated in a conventional strip electrogalvanization plant on either side with a zinc layer, whose thickness was 7.5 μm. The tensile strength of the full-hard material was still 841 MPa after electrogalvanization.

Electrogalvanized, rolling-hardened cold strip obtained in this a way was subsequently provided with a colour coat. Thin plates for rolling gates, which apart from low weight and good heat insulation quality are characterized by high buckling resistance, could be deformed with no problem by roll forming.

1. Cold-rolled flat product,
produced from a low alloy steel, which in addition to iron and unavoidable impurities contains (in % by weight) up to 0.45% of C, up to 2.20% of Si, up to 2.50% of Mn, up to 0.12% of P, up to 0.025% of S, up to 2.0% of Al, up to 0.15% of Ti, up to 0.09% of Nb, a total of up to 1.0% of Cr and Mo, up to 0.2% of V and up to 0.005% of B,
having a thickness of 0.1-4 mm,
being in the rolling-hardened state and thereby possessing a tensile strength of 700-1000 MPa and
which is coated with a zinc layer, which is applied by electrogalvanization and has a layer thickness of up to 12 μm.

2. Cold-rolled flat product according to claim 1, wherein the product has a thickness of 0.1-3 mm.

3. Cold-rolled flat product according to claim 2, wherein the product has a thickness no greater than 1.0 mm.

4. Cold-rolled flat product according to claim 1, wherein the zinc layer is at least 2 μm thick.

5. Cold-rolled flat product according to claim 4, wherein the zinc layer is 2-10 μm thick.

6. Cold-rolled flat product according to claim 1, including at least one further layer on the zinc layer.

7. Process for producing a galvanized rolling-hardened cold-rolled flat product possessing a tensile strength of 700-1000 MPa, the method comprising
producing a hot strip is produced from a steel, which in addition to iron and unavoidable impurities contains (in % by weight) up to 0.45% of C, up to 2.20% of Si, up to 2.50% of Mn, up to 0.12% of P, up to 0.025% of S, up to 2.0% of Al, up to 0.15% of Ti, up to 0.09% of Nb, a total of up to 1.0% of Cr and Mo, up to 0.2% of V and up to 0.005% of B,
cold-rolling the hot strip with a rolling reduction of more than 30% to form a flat product having a thickness of 0.1-0.4 mm,
and
subjecting the cold-rolled flat product in a rolling-hardened state to electrogalvanization, to apply a zinc layer up to 12 μm thick onto the cold-rolled flat product.

8. Process according to claim 7, wherein the cold-rolled flat product is cold-rolled to a thickness of 0.1-1 mm.

9. Process according to claim 7, wherein the thickness of the zinc layer is at least 2 μm.

10. Process according to claim 9, wherein thickness of the zinc layer is 4-8 μm.

11. Process according to claim 7, further comprising applying at least one further layer onto the zinc layer.

12. Process according to claim 7, wherein the cold rolling reduction reached during cold-rolling is at least 50%.
